(19) United States
(12) Patent Application Publication
(10) Pub. No.: US 2006/0209957 A1
(43) Pub. Date: Sep. 21, 2006

(54) Motion sequence pattern detection

(75) Inventors: Abraham Karel Riemens, Eindhoven (NL); Ardjan Dommisse, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., BA Eindhoven (NL)

(21) Appl. No.: 10/535,811

(22) PCT Filed: Oct. 29, 2003
(86) PCT No.: PCT/IB03/04898

§ 371 Date: May 23, 2005

(30) Foreign Application Priority Data
Nov. 26, 2002 (EP) 02079911.0

(51) Int. Cl. H04N 11/02

(52) U.S. Cl. 375/240.16

(57) ABSTRACT

A motion sequence pattern detector (200,300) for detecting a periodic pattern of motion sequences within a succession of video fields (100,102) comprises a motion detection unit (202) for detecting presence of motion between pairs of fields of the succession of video fields (100,102) by means of computing differences between pixel values derived from first and second fields of the pairs of fields, succeeded by comparing the differences with a number of predetermined pixel value difference thresholds and for outputting motion detection signals for the pairs of fields on basis of the comparisons; and a pattern recognition unit (204) for detecting the periodic pattern by comparing the number of sequences of the motion detection signals for the pairs of fields with a predetermined sequence. If for one of the number of sequences the periodic pattern is detected then a final output is generated which indicates that the succession of video fields corresponds to film mode.

The invention relates to a motion sequence pattern detector for detecting a periodic pattern of motion sequences within a succession of video fields, comprising:

a motion detection unit for detecting presence of motion between pairs of fields of the succession of video fields by means of computing differences between pixel values derived from first and second fields of the pairs of fields, succeeded by comparing the differences with a predetermined threshold and for outputting motion detection signals for the pairs of fields on basis of the comparison; and

a pattern recognition unit for detecting the periodic pattern by comparing a sequence of the motion detection signals for the pairs of fields with a predetermined sequence.

The invention further relates to an image processing apparatus, comprising:

receiving means for receiving a signal corresponding to a succession of video fields;

a motion sequence pattern detector as described above; and

an image processing unit for computing a sequence of output images on basis of the succession of video fields, the image processing unit being controlled by the motion sequence pattern detector.

The invention further relates to a method of detecting a periodic pattern of motion sequences within a succession of video fields, comprising:

detecting presence of motion between pairs of fields of the succession of video fields by means of computing differences between pixel values derived from first and second fields of the pairs of fields, succeeded by comparing the differences with a predetermined threshold and for outputting motion detection signals for the pairs of fields on basis of the comparison; and

detecting the periodic pattern by comparing a sequence of the motion detection signals for the pairs of fields with a predetermined sequence.

When focussing on picture rates, three formats can be distinguished:

50 Hz video: A transmission standard, commonly known as PAL or SECAM that comprises 50 interlaced fields per second. Each frame comprises 625 lines of which the even and odd lines are alternatingly transmitted as fields. The 50 Hz video standard is used in most of the world except Japan and North America.

60 Hz video: A transmission standard, commonly known as NTSC that comprises 60 (59.94 to be exact) interlaced fields per second. Each frame comprises 525 lines of which the even and odd lines are alternatingly transmitted as fields. The 60 Hz video standard is used in Japan and North America.

24 Hz film: Film corresponds to a method of recording moving images on a long strip of transparent material. The frame rate of 24 images per second is a compromise between the ability to capture motion and the amount of film required per time interval. The standard is older than the video transmission standards. Attempts were made to adapt the frame rate to 25 and 30 images per second, in order to become more compatible with transmission standards. Except for some exceptions, e.g. commercials, these frame rates did not find major ground in the motion picture industry. Therefore, 24 Hz film remains the most commonly used standard for motion pictures.

When television became a popular medium, the need for new content increased. This called for format conversion methods. Besides converting motion pictures to television, television shows were exchanged between different transmission standards. This content also needed conversion. Later, when the television was dominant, video material was converted to film, e.g. to show television commercials in cinemas. Because of both artistic and economic reasons, the motion picture industry still applies the same procedure to transfer the film format to the video formats.

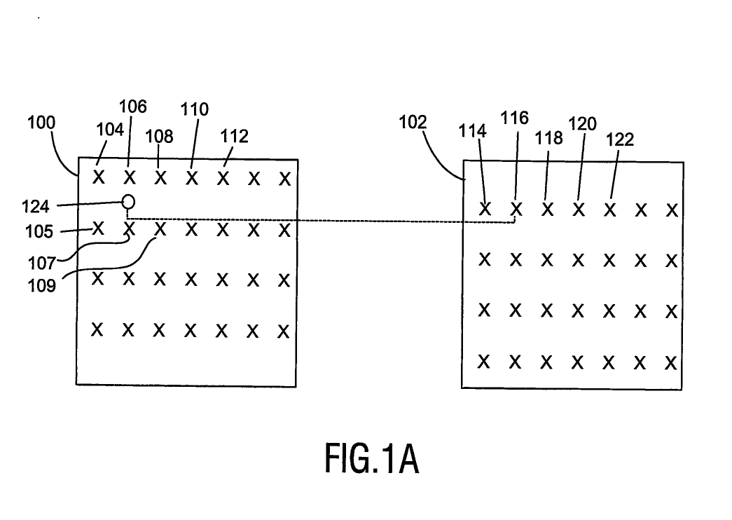

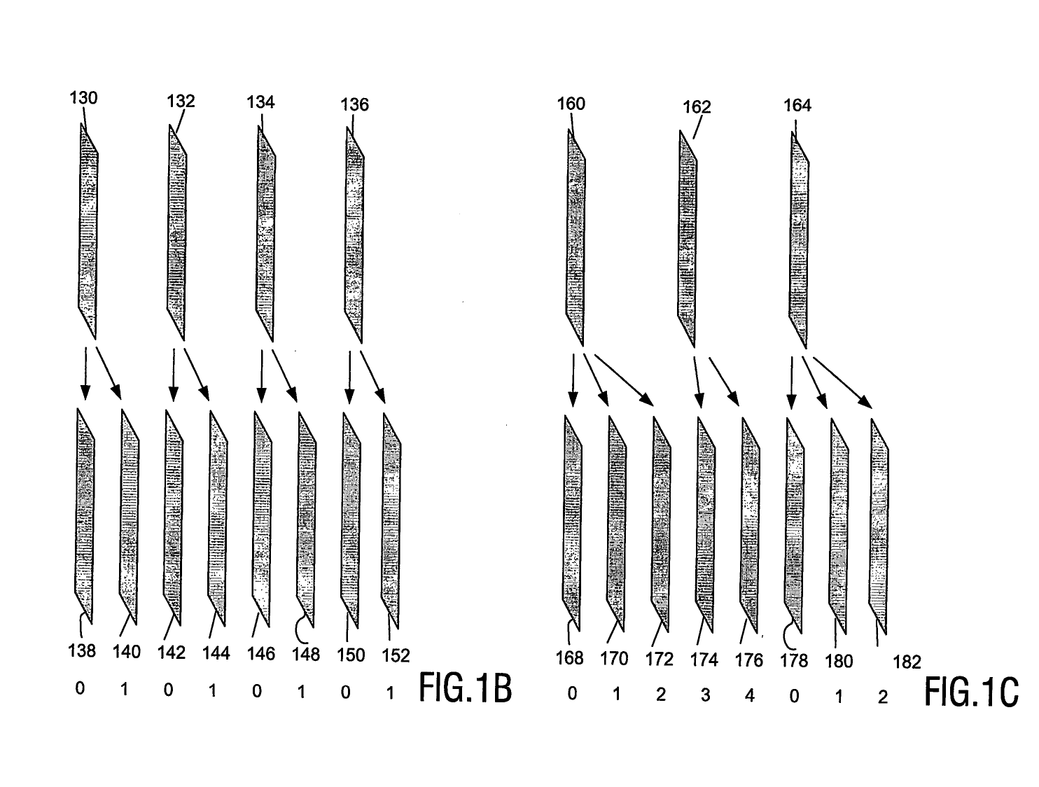

The process to transfer film to video is called the telecine process. One of the many implementations of this process is to illuminate the film and capture light coming through the film with a video camera and advancing the film in the vertical blanking period of the video signal. To change the frame rate from 24 Hz film to 50 Hz video or 60 Hz video, a process called “pull-down” is used. Pull-down is a method where the previous picture of the film is repeated until a new one is available. This method can easily be implemented mechanically. To transfer 24 Hz film to 50 Hz video, the picture rate of the film is increased to 25 pictures per second by running the film slightly faster. The four percent increase of speed and pitch of the sound is not regarded as annoying by the general public. Then, each film picture is scanned twice, creating two video fields. This method is called 2:2 pull-down. See also FIG. 1B. To transfer 24 Hz film to 60 Hz video, speed up to 30 Hz is not desired, since the speed up and the change in pitch of the sound is regarded as unacceptable by the general public. Therefore another method is used, where every even film picture is repeated three times while every odd film picture is repeated two times. This creates an increase of frame rate by a factor 2.5, resulting in a 60 Hz video signal. This method is called 3:2 pull down. See also FIG. 1C.

An image processing apparatus, like a TV, might comprise an image processing unit for computing from a series of original input images a larger series of output images. In that case, a number of the output images are temporally located between successive original input images. This computing is typically known as image rate conversion. For image rate conversion it is relevant to determine the type of the acquisition source of the received images. That means that for achieving a good image quality, it has to be detected whether the received images originate from a film camera which acquired images in a progressive scan mode at a lower image rate or originate from a video camera which acquired images at the image rate of the video signal. Based on that detection, the received video fields are combined to form images. In the case that the received video fields correspond to film then two successive fields can be merged relatively easily. In the case that the received video fields correspond to video then an interpolation of pixels values of the video fields is required which is controlled by the detected motion in the images. Incorrect handling of a video mode signal as film mode can cause severe artifacts which are clearly visible in the output images. These artifacts are known as “forks”, “mouse teeth”, “comb effect” or “zippers”. False video mode detection is less severe, but also yields artifacts.

In general, the signal as received by the image processing apparatus does not comprise an explicit indication of the type of acquisition source of the succession of the video fields. As a result, this information has to be extracted from the video fields themselves. Typically this is done by means of detecting a motion sequence pattern.

An embodiment of the motion sequence pattern detector of the kind described in the opening paragraph is known from U.S. Pat. No. 4,982,280. This patent specification discloses a motion sequence pattern detector being arranged to detect a periodic pattern of motion sequences within a succession of video fields, such as film mode or progressive scan mode. The motion sequence pattern detector comprises a motion detector for detecting the presence of motion from increment to increment within predetermined increments of the succession of video fields and for thereupon outputting a first motion detection signal for each said increment. The motion detector computes differences between pixel values of successive video fields and compares the computation results with a threshold to reduce the effect of noise. The motion sequence pattern detector further comprises logic circuitry responsive to the first motion detection signal for detecting the periodic pattern of motion sequences within the succession of video fields.

Typically, noise is hard to distinguish from video motion. As noise differs from one to the next field, it is often recognized as video motion. Therefore the known detector uses a threshold to distinguish noise from video motion. When a pixel value difference, i.e. luminance difference, exceeds the threshold, then it is assumed that there is motion. When the luminance difference does not exceed the threshold, then it is assumed that the difference is caused by noise. Hence, the selection of the appropriate value of the threshold is crucial.

It is an object of the invention to provide a motion sequence pattern detector of the kind described in the opening paragraph which is relatively noise robust.

This object of the invention is achieved in that the motion sequence pattern detector is further arranged:

to determine further motion detection signals for the pairs of fields on basis of a further predetermined threshold which is different from the predetermined threshold;

to compare a further sequence of the further motion detection signals with the predetermined sequence; and

to detect the periodic pattern of motion sequences on basis of both comparing the sequence of the motion detection signals with the predetermined sequence and comparing the further sequence of the further motion detection signals with the predetermined sequence. By applying multiple thresholds and combining the multiple results of the various comparisons between the various sequences of various motion detection signals with the predetermined sequence a robust pattern detection is achieved. Instead of tuning to or selecting one pixel value difference threshold, which might be inappropriate, a number of pixel value difference thresholds are used of which at least one is appropriate. The eventual detection of the periodic pattern is based on at least the pixel value difference threshold which is appropriate.

An embodiment of the motion sequence pattern detector according to the invention is arranged to generate a mode signal indicating the nature of the succession of video fields as being film mode on basis of comparing the sequence of the motion detection signals with the predetermined sequence and comparing the further sequence of the further motion detection signals with the predetermined sequence. This motion sequence pattern detector is a so-called film detector which is arranged to detect whether the succession of video fields originate from a film camera which captured the images with a progressive scan. If the film detector does not detect a motion sequence pattern which matches with film or alternatively if it detects a motion sequence pattern which matches with video mode, i.e. captured in interlaced mode, then this embodiment of the motion sequence pattern detector according to the invention is arranged to generate a mode signal indicating the nature of the succession of video fields as being video mode.

An embodiment of the motion sequence pattern detector according to the invention is arranged to generate the mode signal indicating the nature of the succession of video fields as being film mode if the sequence of motion detection signals corresponds to the predetermined sequence or the further sequence of the further motion detection signals corresponds to the predetermined sequence. In other words, if on basis of one of the applied pixel value difference thresholds it is determined that the nature of the succession of video fields corresponds to film mode, then the final result is that this embodiment of the motion sequence pattern detector according to the invention generates the mode signal indicating the nature of the succession of video fields as being film mode. If the sequence of motion detection signals does not correspond to the predetermined sequence and the further sequence of the further motion detection signals does not correspond to the predetermined sequence, then the motion sequence pattern detector according to this invention generates the mode signal indicating the nature of the succession of video fields as being video mode.

An embodiment of the motion sequence pattern detector according to the invention comprises:

a further pattern recognition unit for detecting the periodic pattern by comparing the further sequence of the further motion detection signals with the predetermined sequence; and

a decision unit for deciding whether the periodic pattern is detected by combining a first result of comparing the sequence of the motion detection signals for the pairs of fields with the predetermined sequence and a second result of comparing the further sequence of the further motion detection signals with the predetermined sequence. An advantage of this embodiment according to the invention is that a part of the processing, especially the motion measurement for the multiple pixel value difference thresholds, are performed in parallel. As a consequence no additional time delay is introduced.

In an embodiment of the motion sequence pattern detector according to the invention the motion detection unit is arranged to determine a histogram of differences between pixel values derived from a first one of the fields and a second one of the fields and arranged to determine a first one of the motion detection signals on basis of a first number of differences between pixel values belonging to a first bin of the histogram and to determine a first one of the further motion detection signals on basis of a sum of the first number of the differences between pixel values belonging to the first bin and a second number of differences between pixel values belonging to a second bin of the histogram. An advantage of this embodiment according to the invention is that the differences between pixel values have to be computed only once but are used a number of times. Hence, an advantage is a limited computing resource usage.

It is another object of the invention to provide an image processing apparatus of the kind described in the opening paragraph which comprises a motion sequence pattern detector which is relatively noise robust.

This object of the invention is achieved in that the motion sequence pattern detector is further arranged:

to determine further motion detection signals for the pairs of fields on basis of a further predetermined threshold which is different from the predetermined threshold;

to compare a further sequence of the further motion detection signals with the predetermined sequence; and

to detect the periodic pattern of motion sequences on basis of both comparing the sequence of the motion detection signals with the predetermined sequence and comparing the further sequence of the further motion detection signals with the predetermined sequence. The image processing unit of the image processing apparatus might support one or more of the following types of image processing:

Video compression, i.e. encoding or decoding, e.g. according to the MPEG standard.

De-interlacing: Interlacing is the common video broadcast procedure for transmitting the odd or even numbered image lines alternately. De-interlacing attempts to restore the full vertical resolution, i.e. make odd and even lines available simultaneously for each image;

Image rate conversion: From a series of original input images a larger series of output images is calculated. Output images are temporally located between two original input images; and

Temporal noise reduction. This can also involve spatial processing, resulting in spatial-temporal noise reduction.

The image processing apparatus optionally comprises a display device for displaying the output images. The image processing apparatus optionally comprises storage means for storage of images: either the input or the output images. The image processing apparatus might e.g. be a TV, a set top box, a VCR (Video Cassette Recorder) player, a satellite tuner, or a DVD (Digital Versatile Disk) player or recorder.

It is another object of the invention to provide a method of the kind described in the opening paragraph which is relatively noise robust.

This object of the invention is achieved in that the method is characterized in

determining further motion detection signals for the pairs of fields on basis of a further predetermined threshold which is different from the predetermined threshold;

comparing a further sequence of the further motion detection signals with the predetermined sequence; and

detecting the periodic pattern of motion sequences on basis of both comparing the sequence of the motion detection signals with the predetermined sequence and comparing the further sequence of the further motion detection signals with the predetermined sequence.

Modifications of motion sequence pattern detector and variations thereof may correspond to modifications and variations thereof of the method and of the image processing apparatus described.

These and other aspects of the motion sequence pattern detector, of the method and of the image processing apparatus according to the invention will become apparent from and will be elucidated with respect to the implementations and embodiments described hereinafter and with reference to the accompanying drawings, wherein:

FIG. 1A schematically shows two fields of one frame;

FIG. 1B schematically shows 2:2 pull-down;

FIG. 1C schematically shows 3:2 pull-down;

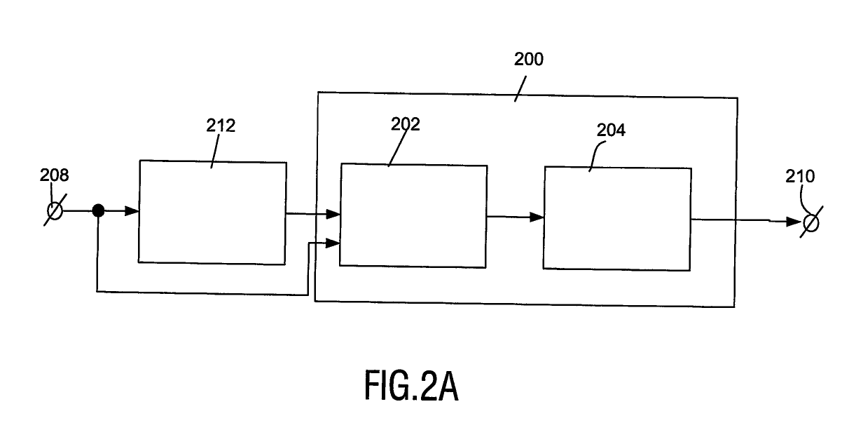

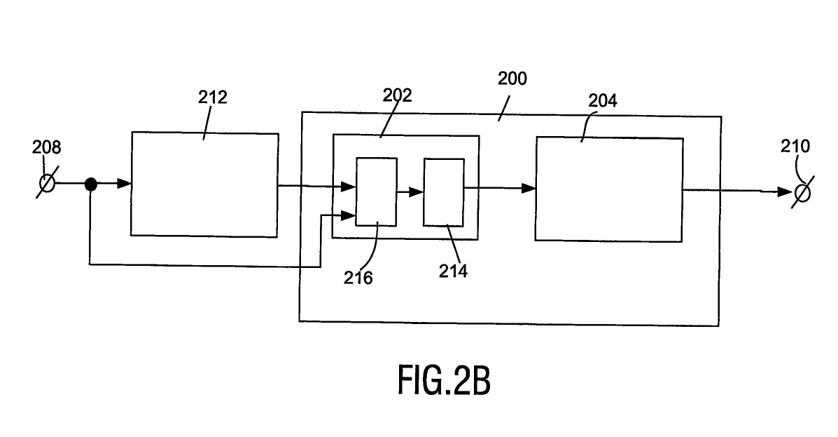

FIG. 2A schematically shows an embodiment of the motion sequence pattern detector according to the invention;

FIG. 2B schematically shows a detail of the motion detection unit of the motion sequence pattern detector according to the invention;

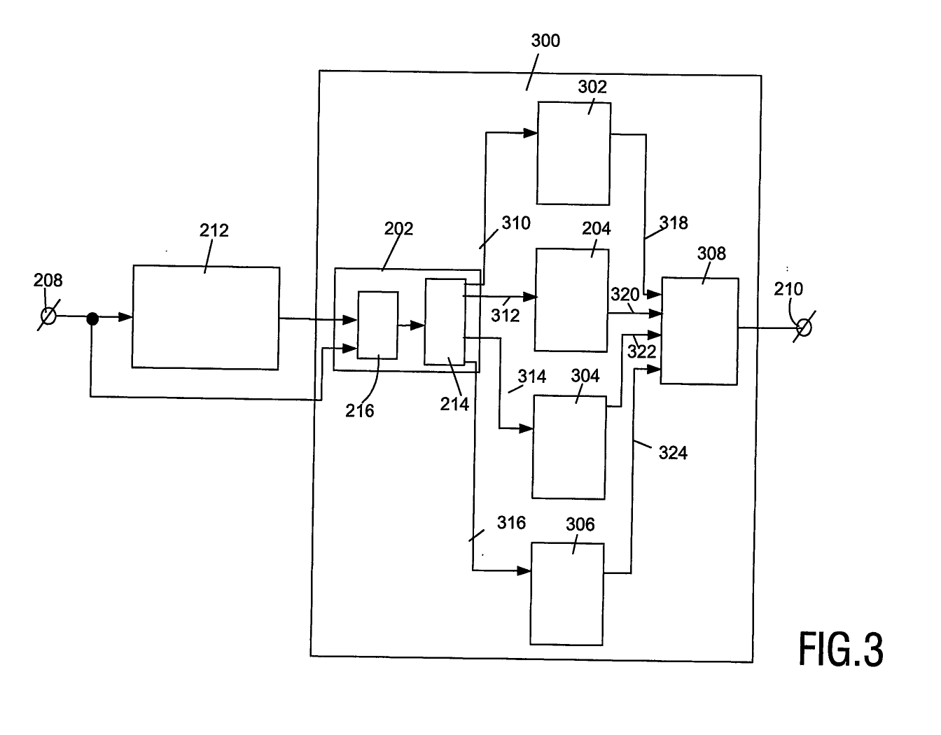

FIG. 3 schematically shows an embodiment of the motion sequence pattern detector according to the invention, comprising a number of pattern recognition units;

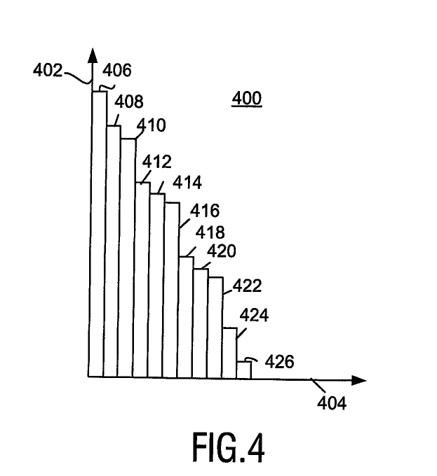

FIG. 4 schematically shows a histogram of pixel value differences, which is computed and applied by the motion sequence pattern detector as described in connection with FIG. 2 and FIG. 3; and

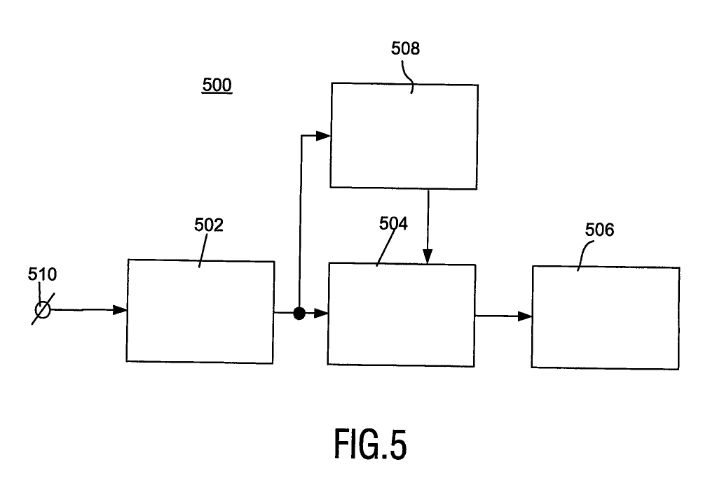

FIG. 5 schematically shows an embodiment of the image processing apparatus 500 according to the invention.

Same reference numerals are used to denote similar parts throughout the figures.

FIG. 1A schematically shows two successive fields 100, 102 of a video signal. The first field 100 comprises the pixel values, e.g. 104-112 of the odd lines of the frame and the second field 102 comprises the pixel values, e.g. 114-122 of the even lines of the frame. For instance at frame coordinates corresponding to pixel 116 of the second field 102 there is no pixel value 124 directly available in the first field 100. That means that if a pixel value 124 is required that this pixel value has to be derived from other pixel values. For example, this pixel value is derived can be calculated by means of an interpolation of pixel values of the first field 100, e.g. by means of an interpolation based on the pixel values 104-109. Optionally less pixel values are taken into account. An interpolation might also include an order statistical operation such as a median operation. It may also include pixels from field 102 or from a (not depicted) field preceding field 100.

FIG. 1B schematically shows 2:2 pull-down. An input stream of pictures 130-136 with a frequency of 25 Hz is up-converted to an output stream of video fields 138-152 with a frequency of 50 Hz. The different phases {0, 1} of the video fields are denoted below the video fields 138-152. This film phase indicates the position in the repetition pattern and is typically calculated in a film detector.

FIG. 1C schematically shows 3:2 pull-down. An input stream of pictures 160-164 with a frequency of 24 Hz is up-converted to an output stream of video fields 168-182 with a frequency of 60 Hz. The different phases {0, 1, 2, 3, 4} of the video fields are denoted below the video fields 168-182.

FIG. 2A schematically shows an embodiment of the motion sequence pattern detector 200 according to the invention. At the input connector 208 of the motion sequence pattern detector 200 an interlaced luminance signal is provided. This input can be denoted as a three-dimensional luminance function F(\vec{x}, n), with the vector \vec{x} comprising two spatial coordinates x and y and n being a temporal coordinate corresponding to the field number. Because the video signal is interlaced, the pixel values of every odd or every even line are undefined. At the output connector 210 a set of discrete signals indicating the mode and phase of the input are provided. Table 1 lists the different modes and the possible values of the phase for each of these modes.

TABLE 1
modes:

| Modes | Phases |
|---|---|
| Video mode | {0} |
| 2:2 pull-down film mode | {0, 1} |
| 3:2 pull-down film mode | {0, 1, 2, 3, 4} |

The motion sequence pattern detector 200 comprises a motion detection unit 202 and a pattern recognition unit 204. Optionally the motion sequence pattern detector 200 comprises a video memory 212 for temporarily storage of a video field. Alternatively, the video memory 212 is part of a shared memory device. The working of the motion sequence pattern detector 200 is as follows. Given a predetermined pixel value difference threshold, the motion detection unit 202 is arranged to compute a motion measure for each pair of fields of the succession of video fields. In other words, based on a predetermined pixel value difference threshold, for each pair of video fields a motion value is determined which is an indication of the amount of motion between the first and second field of each pair. This motion value is determined by computing differences between pixel values derived from first and second fields of the pairs of fields, succeeded by comparing the differences with a predetermined pixel value difference threshold. If a difference between pixel values is larger than the predetermined pixel value difference threshold, then it is assumed that for that pixel, i.e. coordinate, there is motion. In that case a pixel motion counter is increased. By testing all pixels of a field, eventually the pixel motion counter represents the number of pixels with motion. That means that the pixel motion counter representation corresponds with the motion value for the pair of video fields under investigation. It should be noted that alternative methods for computing a motion value are possible, e.g. including some filtering.

It will be clear that by adjusting the value of the predetermined pixel value difference threshold, the eventual value of the motion value for that pair of fields changes. With a relatively low value of the predetermined pixel value difference threshold, the probability is high that minor differences between pixel values which are caused by noise, are interpreted, i.e. counted, as motion. At the other hand, with a relatively high value of the pixel value difference threshold, the probability is high that large differences, which are actually caused by movement, are not interpreted as motion. To overcome this dilemma, for a number of predetermined pixel value difference thresholds respective motion values are computed for each of the pairs of video fields. The values of these predetermined pixel value difference thresholds range from relatively low to relatively high. Typically 8 different predetermined pixel value difference thresholds are applied. Preferably the differences between the values of these pixel value difference thresholds are not mutually equal. For instance, if the number of different luminance values of F(\vec{x}, n) equals 256 then the values of the predetermined pixel value difference thresholds are 2, 4, 6, 8, 10, 14, 20 and 28 respectively.

For each of the predetermined pixel value difference thresholds a series of motion values is computed for the pairs of fields. These motion values are provided as motion detection signals to the pattern recognition unit 204 which is designed to detect a periodic pattern by comparing the sequences of the motion detection signals for the pairs of fields with a predetermined sequence. Possible periodic patterns are listed in Table 2.

TABLE 2
periodic patterns:

| Mode | Periodic pattern |
|---|---|
| Video mode | HHHHHHHHHHHHHH |
| 2:2 pull-down film mode | HLHLHLHLHLHLHLH |
| 3:2 pull-down film mode | HLHLLHLHLLHLHLL |

In Table 2 the symbol H stands for a high motion value for the video fields, i.e. the actual value of the motion detection signal is high. The symbol L stands for a low motion value for the video fields.

The motion sequence pattern detector 200 according to the invention is designed such that if a periodic pattern corresponding to film mode is detected for one of the predetermined pixel value difference threshold that then at the output connector 210 of the motion sequence pattern detector 200 the discrete signal indicates that the mode is film. Also the film phase is provided. If for none of the predetermined pixel value difference thresholds a periodic pattern corresponding to film mode is detected then at the output connector 210 of the motion sequence pattern detector 200 the discrete signal indicates that the mode is video.

Although the fact that for one of the predetermined pixel value difference thresholds the periodic pattern corresponding to film mode is detected, the probability is high that for other values of the predetermined pixel value difference threshold the periodic pattern corresponding to film mode is not detected. That is disregarded. It is assumed that with an inappropriate value of the predetermined pixel value difference threshold no periodic pattern corresponding to film can be detected. That means that it is assumed that a series of motion values, being computed on basis of an inappropriate predetermined pixel value difference threshold, comprises values which are mutually substantially equal. In other words, such a series of motion values matches with a periodic pattern that corresponds to video: HHHHHHHHH. Hence, it is also assumed that with an appropriate value of the predetermined pixel value difference threshold a periodic pattern corresponding to film can be detected.

The motion detection unit 202 and the pattern recognition unit 204 may be implemented using one processor. Normally, these functions are performed under control of a software program product. During execution, normally the software program product is loaded into a memory, like a RAM, and executed from there. The program may be loaded from a background memory, like a ROM, hard disk, or magnetically and/or optical storage, or may be loaded via a network like Internet. Optionally an application specific integrated circuit provides the disclosed functionality.

FIG. 2B schematically shows a detail of the motion detection unit 202 of the motion sequence pattern detector 200 according to the invention. It is depicted that the motion detection unit 202 comprises a difference operation unit 216 and an outputting unit 214 which is arranged to provide multiple motion detection signals for the respective predetermined pixel value difference thresholds. This aspect will be explained in more detail in connection with FIG. 4. The difference operation unit 216 is arranged to compute a difference between a first pixel value 124 derived from a first video field 100 and a second pixel value 116 directly taken from a second video field 102. The first pixel value 124 is computed by means of taking the median value of the pixel values 106 and 107 of the first video field 100 and pixel value 116 of the second video field 102. A pixel value may also be derived from a third video field which precedes the first video field 100. This third video field is not depicted. The difference between the first 124 and second pixel value 116 is applied to compute a sample of a histogram 400 of differences. (See also the description in connection with FIG. 4). Based on this histogram 400 the multiple motion detection signals for the respective predetermined pixel value difference thresholds are determined. A first one of the motion detection signals 310 is determined on basis of a first number of differences between pixel values belonging to a first bin 406 of the histogram 400. A second one of the motion detection signals 312 is determined on basis of a sum of the first number of the differences between pixel values belonging to the first bin 406 and a second number of differences between pixel values belonging to a second bin 408 of the histogram 400. That means that the first predetermined pixel value difference threshold corresponds with the maximum value of the first bin 406 and the second predetermined pixel value difference threshold corresponds with the maximum value of the second bin 408.

FIG. 3 schematically shows an embodiment of the motion sequence pattern detector according to the invention comprising a number of pattern recognition units 204 and 302-306. Each of these pattern recognition units 204 and 302-306 is arranged to detect whether the respective motion detection signals 310-316 match with a periodic pattern. That means that these pattern recognition units 204 and 302-306 are designed to compare sets of samples of the discrete values of the respective motion detection signals 310-316 with a list of values that represents the periodic pattern to be detected. The intermediate results 318-324 of these comparisons are outputted to a final decision unit 308 which is arranged to combine these intermediate results to a final result, indicating the mode and phase.

FIG. 4 schematically shows a histogram 400 of pixel value differences, which is computed and applied by the motion sequence pattern detector as described in connection with FIG. 2 and FIG. 3. The x-axis 404 represents the difference between related pixel values as described in connection with FIG. 1A and FIG. 2B. The y-axis represents the number of pixels that differ less than a predetermined difference but more then another predetermined difference. The histogram 400 comprises a number of bins 406-426. Each bin corresponds to a certain range of differences between pixel values. E.g. the first bin 406 comprises the absolute differences between pixel values of a first and a second video field, which are higher then zero but less then or equal to two luminance units and the second bin 408 comprises the absolute differences between pixel values of a first and a second video field, which are higher then two but less then or equal to four luminance units. In that case, the motion value for a first predetermined pixel value difference threshold, which is equal to two luminance units, corresponds with the value of the first bin 406 and the motion value for a second predetermined pixel value difference threshold, which is equal to four luminance units, corresponds with the sum of the value of the first bin 406 and of the value of the second bin 408. It will be clear that by determining the histogram 400 once, computing the various motion values for the different predetermined pixel value difference thresholds is relatively easy. It is just an integration of the values of the appropriate bins 406-426. This example illustrates that there is a relation between the values of the predetermined pixel value difference thresholds and the bins 406-426 of the histogram 400.

FIG. 5 schematically shows an embodiment of the image processing apparatus 500 according to the invention, comprising:

Receiving means 502 for receiving a signal representing input images comprising video fields. The signal may be a broadcast signal received via an antenna or cable but may also be a signal from a storage device like a VCR (Video Cassette Recorder) or Digital Versatile Disk (DVD). The signal is provided at the input connector 510;

The motion sequence pattern detector 508 as described in connection with any of the FIG. 2A, 2B or 3;

An image processing unit 504 for calculating a sequence of output images on basis of the succession of video fields. The image processing unit 504 is controlled by the motion sequence pattern detector 508. Control means that the output of the motion sequence pattern detector 508 influences the image processing unit 504. For instance, if the image processing unit 504 is arranged to perform de-interlacing then the output (mode and phase) is used to combine corresponding video fields to images; and

A display device 506 for displaying the output images of the image processing unit 504. This display device 506 is optional.

The image processing apparatus 500 might e.g. be a TV. Alternatively the image processing apparatus 500 does not comprise the optional display device 506 but provides the output images to an apparatus that does comprise a display device 506. Then the image processing apparatus 500 might be e.g. a set top box, a satellite-tuner, a VCR player, a DVD player or a DVD recorder. Optionally the image processing apparatus 500 comprises storage means, like a hard-disk or means for storage on removable media, e.g. optical disks. The image processing apparatus 500 might also be a system being applied by a film-studio or broadcaster.

It should be noted that the above-mentioned embodiments illustrate rather than limit the invention and that those skilled in the art will be able to design alternative embodiments without departing from the scope of the appended claims. In the claims, any reference signs placed between parentheses shall not be constructed as limiting the claim. The word ‘comprising’ does not exclude the presence of elements or steps not listed in a claim. The word “a” or “an” preceding an element does not exclude the presence of a plurality of such elements. The invention can be implemented by means of hardware comprising several distinct elements and by means of a suitable programmed computer. In the unit claims enumerating several means, several of these means can be embodied by one and the same item of hardware.

1. A motion sequence pattern detector for detecting a periodic pattern of motion sequences within a succession of video fields, comprising:
a motion detection unit for detecting presence of motion between pairs of fields of the succession of video fields by means of computing differences between pixel values derived from first and second fields of the pairs of fields, succeeded by comparing the differences with a predetermined threshold and for outputting motion detection signals for the pairs of fields on basis of the comparison; and
a pattern recognition unit for detecting the periodic pattern by comparing a sequence of the motion detection signals for the pairs of fields with a predetermined sequence, characterized in that the motion sequence pattern detector is further arranged:
to determine further motion detection signals for the pairs of fields on basis of a further predetermined threshold which is different from the predetermined threshold;
to compare a further sequence of the further motion detection signals with the predetermined sequence; and
to detect the periodic pattern of motion sequences on basis of both comparing the sequence of the motion detection signals with the predetermined sequence and comparing the further sequence of the further motion detection signals with the predetermined sequence.

2. A motion sequence pattern detector as claimed in claim 1, characterized in being arranged to generate a mode signal indicating the nature of the succession of video fields as being film mode on basis of comparing the sequence of the motion detection signals with the predetermined sequence and comparing the further sequence of the further motion detection signals with the predetermined sequence.

3. A motion sequence pattern detector as claimed in claim 2, characterized in being arranged to generate the mode signal indicating the nature of the succession of video fields as being film mode if the sequence of motion detection signals corresponds to the predetermined sequence or the further sequence of the further motion detection signals corresponds to the predetermined sequence.

4. A motion sequence pattern detector as claimed in claim 3, characterized in comprising:
a further pattern recognition unit for detecting the periodic pattern by comparing the further sequence of the further motion detection signals with the predetermined sequence; and
a decision unit for deciding whether the periodic pattern is detected by combining a first result of comparing the sequence of the motion detection signals for the pairs of fields with the predetermined sequence and a second result of comparing the further sequence of the further motion detection signals with the predetermined sequence.

5. A motion sequence pattern detector as claimed in claim 3, characterized in that the motion detection unit is arranged to determine a histogram of differences between pixel values derived from a first one of the fields and a second one of the fields and arranged to determine a first one of the motion detection signals on basis of a first number of differences between pixel values belonging to a first bin of the histogram and to determine a first one of the further motion detection signals on basis of a sum of the first number of the differences between pixel values belonging to the first bin and a second number of differences between pixel values belonging to a second bin of the histogram.

6. An image processing apparatus, comprising:
receiving means for receiving a signal corresponding to a succession of video fields;
a motion sequence pattern detector for detecting a periodic pattern of motion sequences within the succession of video fields, as claimed in claim 1; and
an image processing unit for computing a sequence of output images on basis of the succession of video fields, the image processing unit being controlled by the motion sequence pattern detector.

7. An image processing apparatus as claimed in claim 6, characterized in further comprising a display device for displaying the output images.

8. An image processing apparatus as claimed in claim 7, characterized in that it is a TV.

9. An image processing apparatus as claimed in claim 6, characterized in further comprising storage means for storage of the output images.

10. An image processing apparatus as claimed in claim 9, characterized in that it is a DVD recorder.

11. A method of detecting a periodic pattern of motion sequences within a succession of video fields, comprising:
detecting presence of motion between pairs of fields of the succession of video fields by means of computing differences between pixel values derived from first and second fields of the pairs of fields, succeeded by comparing the differences with a predetermined threshold and for outputting motion detection signals for the pairs of fields on basis of the comparison; and
detecting the periodic pattern by comparing a sequence of the motion detection signals for the pairs of fields with a predetermined sequence, characterized in:
determining further motion detection signals for the pairs of fields on basis of a further predetermined threshold which is different from the predetermined threshold;
comparing a further sequence of the further motion detection signals with the predetermined sequence; and
detecting the periodic pattern of motion sequences on basis of both comparing the sequence of the motion detection signals with the predetermined sequence and comparing the further sequence of the further motion detection signals with the predetermined sequence.
